(19) United States
(12) Patent Application Publication
(10) Pub. No.: US 2002/0019800 A1
(43) Pub. Date: Feb. 14, 2002

(54) Method and apparatus for transacting divisible property

(75) Inventor: Brian Mark Shuster, Stateline, NV (US)

Correspondence Address: O'MELVENY & MYERS LLP, 400 So. Hope Street, Los Angeles, CA, 90071-2899, US

(73) Assignee: Ideaflood, Inc.

(21) Appl. No.: 09/860,838

(22) Filed: May 16, 2001

Related U.S. Application Data
(63) Continuation-in-part of application No. 09/773,298, filed on Jan. 31, 2001.
(60) Provisional application No. 60/204,511, filed on May 16, 2000.

(51) Int. Cl. G06F 17/60

(52) U.S. Cl. 705/37

(57) ABSTRACT

A method and apparatus for conducting on-line auctions of divisible property allows a prospective buyer to create a divisible property right, such as a sub-domain name, and initiate an auction for that newly created divisible property right. The divisible property right can then be sold at a market price. In an embodiment of the invention, the method comprises the steps of acquiring registration authority over a divisible property right from an owner, enabling a prospective buyer to select a sub-division of the divisible property right and initiate an auction for the sub-divided property right that extends for a predetermined period of time, receiving bids on the sub-divided property right from additional prospective buyers including the first prospective buyer, and transferring authority over the sub-divided property right to one of the prospective buyers that submits the highest bid during the predetermined time duration of the auction.

### CROSS-REFERENCE TO RELATED APPLICATIONS

This application claims priority pursuant to 35 U.S.C. §119(e) to U.S. Provisional Application No. 60/204,511, filed May 16, 2000, which application is specifically incorporated herein, in its entirety, by reference. This application is also a continuation-in-part of commonly owned co-pending application Ser. No. 09/773,298, filed Jan. 31, 2001.

### BACKGROUND OF THE INVENTION

1. Field of the Invention

The present invention relates to a method for transacting divisible property. In particular, this invention pertains to an automated auction procedure for transacting divisible property via an Internet portal.

2. Description of Related Art

For many years, the global retail market has been characterized as a market in which physical products are sold from physical locations. In recent years, however, this dynamic has undergone a significant change in response to the increasing popularity of the Internet and in particular with the increasing popularity of Internet domain names. It should be appreciated that the Internet is defined here as a collection of interconnected (public and/or private) networks linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

A domain name is a unique address that identifies a computer or network that is connected to the Internet. A particular domain name can be comprised of different domain name levels. Domain names begin with a top level domain name with each subsequent domain name level separated by a dot. Domain level hierarchy is such that top level (level one) domain names are those names located furthest to the right of the entire domain name. These level one domain names include descriptors such as ‘com’, ‘org’, ‘net’, or any other designation approved by the Internet Corporation for Assigned Names and Numbers (ICANN). Level two domain names are located to the immediate left of the top level domain name while level three domain names are to the immediate left of the level two domain names. Additional domain name levels sequentially follow, from right to left, according to this same scheme. For purposes of the discussion herein, domain names are referred to as only the combination of level one and level two domain names. Domain name levels greater than two will, meanwhile, be sequentially referred to as sub-domains from right to left. As an example, in the website “www.sub2.sub1.foo.com”, the term “foo.com” is the domain name while terms “sub1”, “sub2”, and “www” are respectively sub-domains one, two, and three.

According to current domain name architecture and available sales methodology on the Internet, rights to use a single domain name are transferred only to a single entity, which entity then uses that domain name as well as all variants thereof. Legally, this entity has only a license to use the domain name; however, as long as the name is unrelated to someone else's trademark or legal right to use the name, this license awards full administrative sovereignty over the domain name. This entity thus becomes the administrative contact for the particular domain name. As the administrative contact, this entity can speak on behalf of the organization for which the domain name is registered and should be able to answer non-technical questions about the organization's plans for the name and procedures for establishing sub-domains. Also, the administrative contact should be able to represent the organization regarding use of the name. The licensee is commonly referred to in the art as the “owner” of the domain, although an actual ownership interest is not created. For convenience, the licensee will be referred to herein as the “owner” to be consistent with general nomenclature in the art.

Current domain name vendors do not license rights to sub-domain names. This limitation prevents full exploitation of the value of domain names, as many good names, such as “rover.ismydog.com”, are not available for transfer. A further complication limiting the creation of sub-domain/domain name combinations is the current domain naming and resolution architecture. Once a right to use a domain name is transferred, the licensee of that name controls domain name service for all sub-domains related to that domain name.

Domain names have a unique attribute in that they can be divided into many parts in which the original owner's use and enjoyment of the domain name is not affected adversely by the presence of other owners having a divisible portion of that right. For example, a domain name owner can transfer ownership of a sub-domain name to another person, while at the same time retaining ownership of the top level domain name hosting that particular sub-domain and all other sub-domains emanating from it. Moreover, the scope of property rights a domain name owner has extends beyond all existing sub-domain names to include all potential sub-domain names that do not yet exist. The owner of “last.com”, for example, may not have any sub-domain names emanating from “last.com”; however, this owner still owns the property rights of all potential sub-domains that may be created from “last.com”. Therefore, if a prospective sub-domain name buyer wanted to purchase “never.last.com”, it would have to do so with the approval of the owner of “last.com”. In a similar example, the owner of “last.com” may have a mail server associated with this domain name from which electronic mail (e-mail) addresses may be sold. In this example, if a prospective e-mail address buyer wanted to purchase “free@last.com”, it would also have to do so with the approval of the owner of “last.com”. At present, no market exists that allows a buyer to create such properties and purchase these newly created properties at a market-determined price.

It would therefore be desirable to provide a way for buyers to create sub-divisions of these divisible properties, such as sub-domain names and e-mail addresses, and purchase them according to true market values. It should be appreciated that divisible property is defined herein as a virtual property in which a plurality of sub-divisions of this property may be made without adversely affecting the owner of the divisible property.

### SUMMARY OF THE INVENTION

The present invention provides a method and apparatus for conducting on-line auctions of divisible property. More particularly, the method and apparatus allows a prospective buyer to create a divisible property right, such as a sub-domain name, and initiate an auction for that newly created divisible property right. The divisible property right can then be sold at a market price.

In an embodiment of the invention, the method comprises the steps of acquiring registration authority over a divisible property right from an owner, enabling a prospective buyer to select a sub-division of the divisible property right and initiate an auction for the sub-divided property right that extends for a predetermined period of time, receiving bids on the sub-divided property right from additional prospective buyers including the first prospective buyer, and transferring authority over the sub-divided property right to one of the prospective buyers that submits the highest bid during the predetermined time duration of the auction.

A more complete understanding of a method and apparatus for transacting divisible property will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a pyramid diagram showing the current domain naming architecture;

FIG. 2 is an illustration of the current sub-domain naming architecture;

FIG. 3 is a block diagram demonstrating a preferred embodiment of the invention;

FIG. 4 is a flow chart outlining the steps for processing divisible property sale applications from divisible property sellers according to a preferred embodiment of the invention; and

FIG. 5 is a flow chart outlining the steps for processing divisible property auction applications from prospective property buyers according to a preferred embodiment of the invention.

### DETAILED DESCRIPTION OF THE PREFERRED EMBODIMENT

The present invention is directed towards a method for linking divisible property sellers with property buyers. Particularly, this invention satisfies the need for a method in which buyers create custom divisible properties and initiate auctions of these properties via the Internet. In the detailed description that follows, like element numerals are used to describe like elements shown in one or more of the figures.

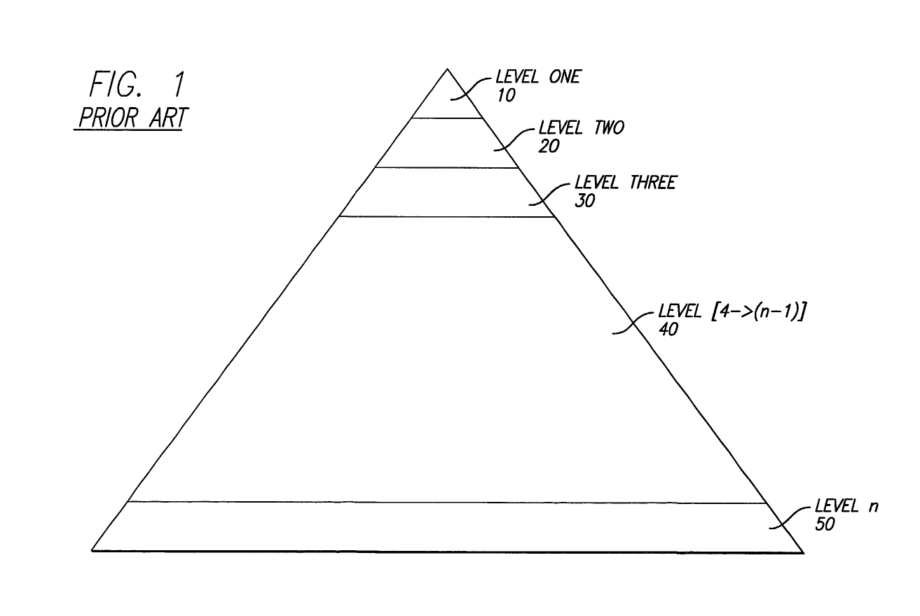

In order to better describe a preferred embodiment, an exemplary embodiment is given here with respect to Internet domain names. It should, however, be appreciated that a plurality of embodiments can be made with respect to other types of divisible properties which are also within the scope and spirit of the present invention. Referring first to FIG. 1, a pyramid diagram reflecting the current domain naming architecture is shown. This naming structure is comprised of several possible domain name levels. The top level of this structure represents all level one domain names 10 available to the Internet community, followed immediately below by all possible level two domain names 20 and then by all possible level three domain names 30. Also included in this diagram are domain name levels four through (n−1) 40 and domain name level n 50, where n represents an undefined maximum number of domain name levels.

As can be seen from FIG. 1, an increasing number of possible domain/subdomain name combinations are available as the number of levels increases. This behavior is better understood by taking an arbitrary domain name and analyzing all possible sub-domain names available to it. In FIG. 2, for example, the domain name “foo.com” 100 can theoretically host such sub-domains as “subdomain1.foo.com” 110, “subdomain2.foo.com” 120, and all other possible sub-domains “subdomainX.foo.com” 130, where “subdomainX” represents every possible alphanumeric combination allowed by ICANN to represent a sub-domain. Consequently, each respective sub-domain 110 120 130 can host other sub-domains 112, 114, 116, 122, 124, 126, 132, 134, and 136. For example, “subdomain1.foo.com” 110 can host “sub1.subdomain1.foo.com” 112, “sub2.subdomain1.foo.com” 114, and all other possible sub-domains “subX.subdomain1.foo.com” 116, where “subX” again represents every possible alphanumeric combination allowed by ICANN to represent a sub-domain. The number of potential domain/sub-domain name combinations continues to rapidly grow until level n. However, since the creation and sub-licensing of sub-domains is the sole responsibility of individual domain name owners, and not a centralized registrar, a communication link between domain name owners and potential sub-domain buyers usually does not exist. Thus, although the number of potential domain/sub-domain name combinations is far greater than the number of simple domain name combinations, domain name registration procedure is structured such that many subdomain names are left unused. This invention addresses the need to fill the void left behind by this procedure.

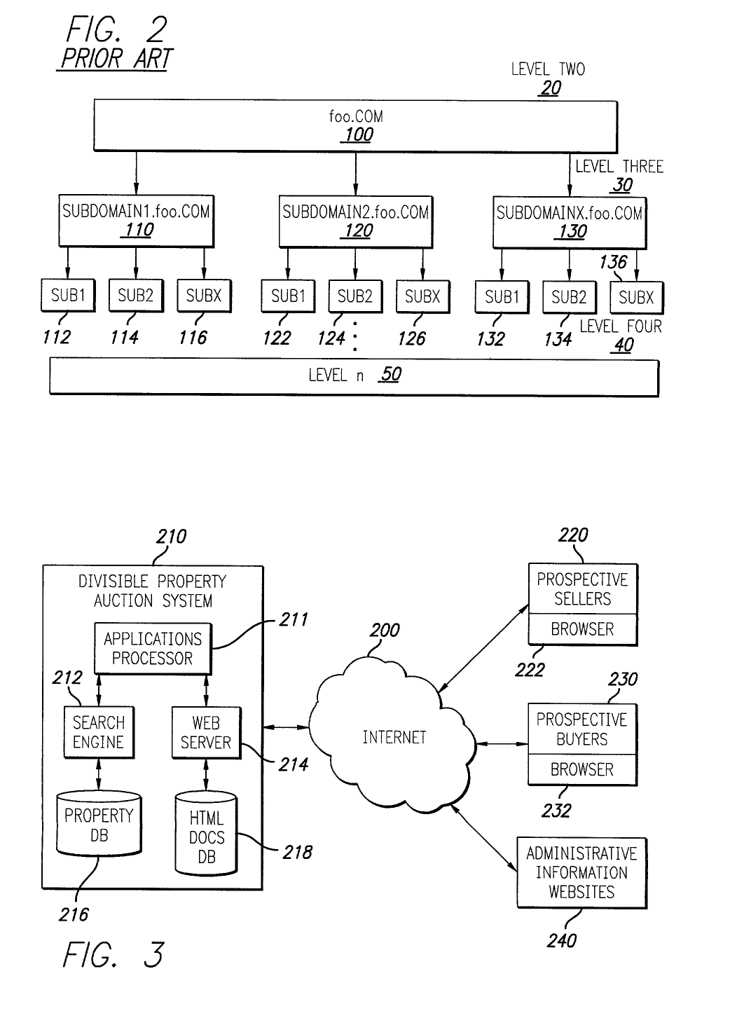

In FIG. 3, a block diagram is illustrated of a wide area network employing a method and apparatus according to an embodiment of the invention. It is anticipated that the present invention operates with a plurality of computers which are coupled together on a wide area network, such as the Internet 20, or other communications network. As illustrated, a divisible property auction system 210 is shown to communicate with prospective divisible property sellers 220, prospective property buyers 230, and administrative service providers 240 via the Internet 200. The divisible property auction system 210 is shown to be further comprised of an applications processor 211 coupled to a search engine 212 connected to a divisible property database 216, and a Web server 214 connected to an HTML (Hyper-Text Markup Language) documents database 218.

As is generally known in the art, search engines such as search engine 212 typically incorporate a database engine, such as a SQL Server™ engine from Microsoft Corporation or Oracle™ database engine, as part of their architecture. It is also well known in the art that such search engines typically perform searches by operating on a string of characters, known as a “query string.” A query string is coded according to a set of rules determined by the database engine and/or a user interface between the database engine and the user. As used herein, a “query” is broader than a “query string,” denoting both the query string and the search logic represented by the query string, whereas “query string” refers only to a string of characters, symbols, or codes used to define a query.

As is also generally known in the art, Web servers such as Web server 214 access a plurality of Web pages, distributable applications, and other electronic files containing information of various types stored in the HTML documents database 218. As a result, Web pages may be viewed on various user computers 220, 230; for example, a particular Web page or other electronic file may be viewed through a suitable application program residing on a user computer 220, 230, such as a browser 222, 232, or by a distributable application provided to the user computer 220, 230, by Web server 214. It should be appreciated that many different user computers, many different Web servers, and many different search servers of various types may be communicating with each other at the same time.

It should be appreciated that prospective divisible property sellers 220 and prospective property buyers 230 may both be represented by any type of computing device that allows a user to interactively browse websites, such as a personal computer (PC) that includes a Web browser application 222 and 232 (e.g., Microsoft Internet Explorer™ or Netscape Communicator™). Suitable user computers 220, 230 respectively equipped with browsers 222, 232 are available in many configurations, including handheld devices (e.g., PalmPilot™), personal computers (PC), laptop computers, workstations, television set-top devices, multi-functional cellular phones, and so forth.

It should be further appreciated that a user identifies a Web page that is desired to be viewed at the user computer 220, 230 by communicating an HTTP (Hyper-Text Transport Protocol) request respectively from the browser application 222, 232. The HTTP request includes the Uniform Resource Locator (URL) of the desired Web page, which may correspond to an HTML document stored in the HTML documents database 218. The HTTP request is routed to the Web server 214 via the Internet 200. The Web server 214 then retrieves the HTML document identified by the URL, and communicates the HTML document across the Internet 200 to the browser application 222, 232. The HTML document may be communicated in the form of plural message packets as defined by standard protocols, such as the Transport Control Protocol/Internet Protocol (TCP/IP).

In a preferred embodiment, divisible property sellers 220 request auction services from the divisible property auction system 210 through its interactive website on the Internet 200. In their request for service, divisible property sellers 220 make a preliminary agreement to transfer all divisible property service records to the divisible property auction system 210. An automated procedure within the divisible property auction system 210 then confirms this transfer with the appropriate divisible property administrative computer system 240. Once this confirmation is complete, authority over the particular divisible property is transferred from the seller 220 to the divisible property auction system 210.

As stated previously, the dynamics of this invention are best understood within the context of an example and in particular within the context of Internet domain name service. In a preferred embodiment, once a domain name is signed up for service, the divisible property auction system 210 makes a query of level one domain name servers to determine where the domain currently points, including its mail exchanger records, ‘www’ sub-domain records, and level one domain records. The divisible property auction system 210 also makes a query of the domain name server that currently serves records for the domain and requests a transfer of all name service records for the domain. The divisible property auction system 210 then updates its own records to reflect the existing name service. A request for a change to the domain name service is then automatically created and submitted to the administrative service provider 240 for the domain and/or sent to the administrative or technical contacts for the domain. Once this transfer in domain name service is complete, requests for this particular domain name are responded to with a statement that name service information for this domain can be found at the divisible property auction server 214.

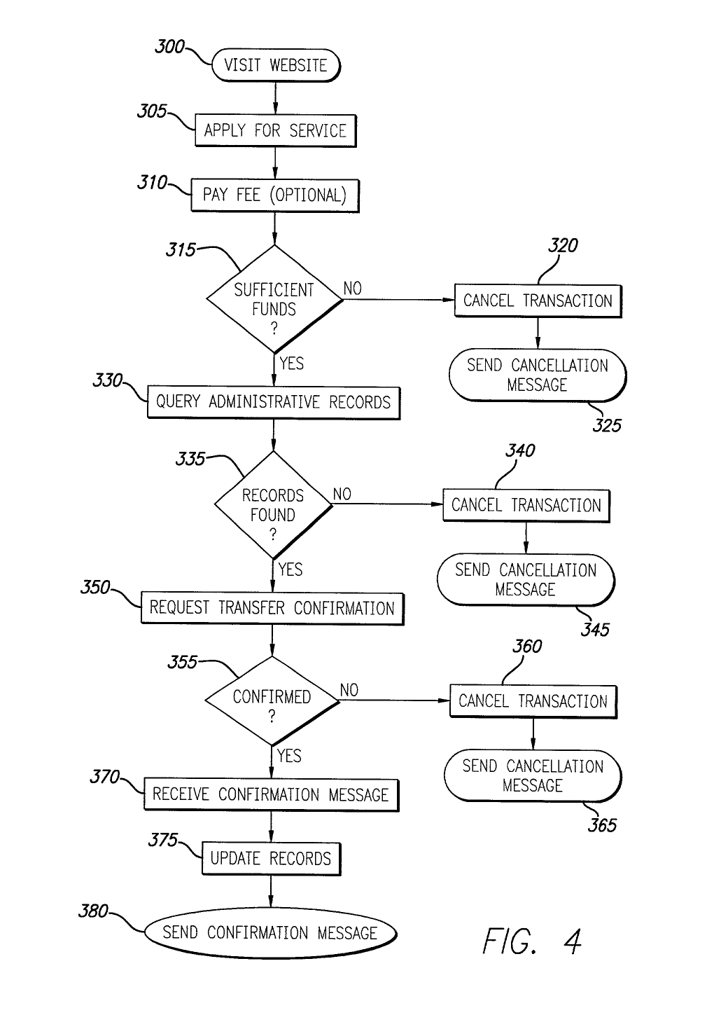

In FIG. 4, a flow chart outlining the steps for processing applications for domain name service from prospective domain name sellers 220 according to a preferred embodiment of the invention is shown. Prospective domain name sellers 220 begin this process by visiting the divisible property auction website at step 300. At this website, domain name sellers 220 fill out an on-line application requesting service at step 305. It should be appreciated that information entered by the domain name seller 220 in this application may include contact information, auction duration time, restrictions on particular sub-domain names, and other types of information deemed appropriate by the management of the divisible property auction system 210.

Once this application is completed, the prospective domain name seller may optionally be required to pay a processing fee (via credit card or other payment method) at step 310. In a preferred embodiment of the invention, no processing fee would be required so as to encourage registration of domain names by seller. If a processing fee is collected, the system may verify that sufficient funds are available at step 315, and if the domain name seller does not have sufficient funds, the transaction is cancelled at step 320 and a cancellation message is sent to the domain name seller 220 at step 325. Conversely, if no processing fee is required or if the seller has sufficient funds, the divisible property auction system 210 then searches the Internet 200 at step 330 for the domain name's administrative records. If domain name administrative records for that particular domain name are found at step 335, a transfer of service confirmation is requested at step 350; otherwise, at step 340 the transaction is cancelled and a cancellation message is sent to the domain name seller 220 at step 345. The divisible property auction system 210 then awaits transfer confirmation from the administrative service provider at step 355. If this transfer is accepted, a confirmation message is received at step 370; otherwise, at step 360 the transaction is cancelled and a cancellation message is sent to the domain name seller 220 at step 365. Upon receiving transfer confirmation from the original administrative service provider 240, the divisible property auction system 210 assigns an Internet Protocol (IP) address to that particular domain and updates its database 216 at step 375. Finally, at step 380, a message is sent to the domain name seller 220 confirming service for that particular domain name. It should be noted that registration for hosting service is dealt with in a separate procedure that is outside the scope of the present invention. Until a hosting service is chosen, only the newly registered domain name, and not a particular website, is linked to the IP address assigned at step 375. This is known in the art as “parking” a domain, and will herein be referred to as such.

People who desire to sub-license a sub-domain from the divisible property auction system 210 follow a similar procedure. As described above, such sub-licensees do not obtain an ownership interest in the sub-domain, but merely obtain a license. Nevertheless, for convenience and clarity, these potential sub-licensees will be referred to as “buyers”. Prospective sub-domain buyers 230 would simply visit the divisible property auction website and purchase available sub-domains under domain names found in the divisible property auction database 216. The revenue generated from this purchase is then distributed between owners of the divisible property auction system 210 and all owners of upper level domains from which the sub-domain buyer 230 is hosting its sub-domain. Upon clearance of payment information (or, optionally, before), name service for the sub-domain is then pointed as directed by the new sub-licensee or owner.

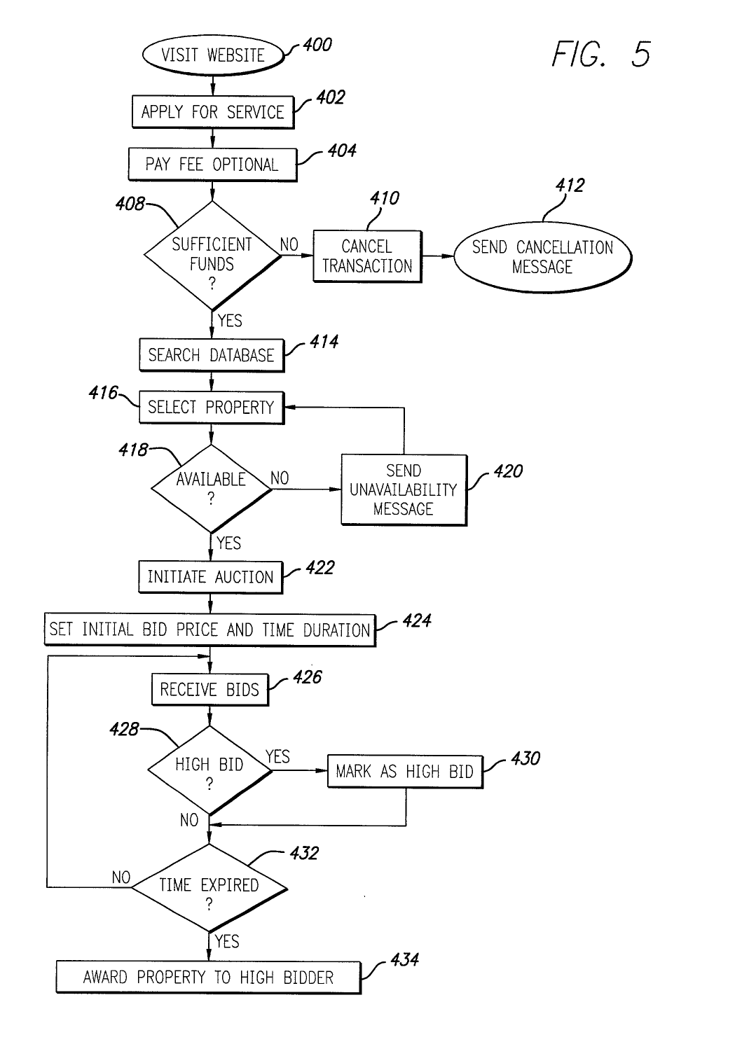

In FIG. 5, a flow chart outlining the steps for processing sub-domain name auction applications from prospective sub-domain name buyers 230 according to a preferred embodiment of the invention is shown. Prospective sub-domain name buyers 230 begin this process by visiting the divisible property auction website at step 400. At step 402, prospective sub-domain name buyers 230 are then prompted to fill out an on-line application requesting service. After applying for service at step 402, the prospective sub-domain name buyer 230 may be required to pay a processing fee (via credit card or other payment method) at step 404. As above, this processing fee is optional, and in the preferred embodiment would not be included so as to encourage registration by prospective sub-domain name buyers. If a processing fee is required, the system may verify that sufficient funds are available at step 408. The transaction is cancelled at step 410 if the prospective sub-domain name buyer has insufficient funds and a cancellation message is sent to the prospective sub-domain name buyer 230 at step 412. If sufficient funds are available or if no processing fee is required, the prospective sub-domain name buyer 230 is then allowed to search through all available domain names within the divisible property auction database 216 at step 414.

After locating a particular domain name at step 414, the prospective sub-domain name buyer selects a desired sub-domain name at step 416. Notably, the selected sub-domain name did not previously exist, and the prospective sub-domain name buyer is essentially creating a new divisible property right at this point. If a selected sub-domain name is unavailable, the system may generate an unavailability message with a list of similar sub-domain names at step 420. The prospective sub-domain name buyer 230 may then be asked to select another sub-domain name at step 416. If the selected sub-domain name is currently available at step 418 (i.e., not previously created), the prospective sub-domain name buyer 230 initiates an auction at step 422. The system sets a minimum bid price (e.g., $10) and a time duration for the auction (e.g., one week) at step 424. These auction parameters may be predefined by the system, or may be selected by the domain name seller 220 during the application process. Alternatively, the prospective sub-domain name buyer 230 may be permitted to define these auction parameters, though it should be appreciated that the prospective sub-domain name buyer would have an incentive to set the minimum bid price low and time duration short so as to discourage competition from other prospective buyers.

Once the on-line auction has begun, the system will receive bids from prospective sub-domain name buyers at step 426. The prospective sub-domain name buyers will be alerted to the minimum bid price and the remaining time left in the auction. With each new bid that is received, the auction system 210 determines at step 428 whether the bid exceeds the previous bids and is thus the high bid. If the bid is the high bid, the system will reflect the high bid as the new minimum bid price at step 430, so prospective sub-domain name buyers will then be alerted to this new information. The system will also determine whether the time duration of the auction has expired at step 432. If the time duration has not expired, the system returns to step 426 to receive additional bids. There is no limit to the number of bids that a prospective sub-domain name buyer may submit, as long as each bid exceeds the minimum price and is submitted within the time duration for the auction. It should be appreciated that this process may repeat many times until the time duration expires, at which time the auction is closed and the sub-domain name is awarded to the prospective sub-domain name buyer that submitted the highest bid at step 434. There may be a further process by which the seller is provided with contact information regarding the sub-domain name buyer with the high bid (e.g., email address), so that the transaction can be finalized and money exchanged. Alternatively, the transaction can be handled entirely by the system.

In a similar embodiment, it should be appreciated that the present invention may also be applied to electronic mail (e-mail) services. In such an embodiment, owners of a particular mail server may provide for auction of a plurality of non-existent e-mail addresses within its e-mail service where, in the above description, these e-mail addresses are analogous to sub-domain names. For example, the owner of “work.com” may provide for auction a plurality of non-existent e-mail addresses emanating from the mail server associated with “work.com”. Within this embodiment, a prospective e-mail address buyer may purchase an e-mail address such as “men@work.com” from the owner of “work.com” where, in the above description, the e-mail address buyer is analogous to a prospective sub-domain name buyer 230.

Having thus described preferred embodiments of a method and apparatus for transacting divisible property, it should be apparent to those skilled in the art that certain advantages of the within system have been achieved. It should also be appreciated that various modifications, adaptations, and alternative embodiments thereof may be made within the scope and spirit of the present invention. The invention is further defined by the following claims.

What is claimed is:

1. A method for selling divisible property, comprising:
acquiring registration authority over a divisible property right from an owner of a property;
enabling a first prospective property buyer to select a sub-division of said divisible property right;
initiating an auction of said selected sub-division of said divisible property right having a predetermined minimum price;
receiving bids on said sub-division of said divisible property from prospective property buyers including at least said first prospective property buyer; and
awarding registration authority over said sub-division of said divisible property right to one of said prospective property buyers that submits the highest bid.

2. The method of claim 1, wherein said acquiring step further comprises receiving a request from said property owner to offer sub-divisions of said divisible property right for bid.

3. The method of claim 1, wherein said acquiring step further comprises locating an administrative service provider associated with said divisible property right.

4. The method of claim 1, wherein said initiating step further comprises initiating said auction having a predetermined time period.

5. The method of claim 4, further comprising terminating said auction when said predetermined time period expires.

6. The method of claim 1, wherein said divisible property further comprises a domain name.

7. The method of claim 1, wherein said divisible property further comprises an e-mail address.

8. A system for selling divisible property rights, comprising:
a server connected to a computer network and having a divisible property auction application executing in association therewith to provide the functions of:
acquiring registration authority over a divisible property right from an owner of a property;
enabling a first prospective property buyer to select a sub-division of said divisible property right;
initiating an auction of said selected sub-division of said divisible property right having a predetermined minimum price;
receiving bids on said sub-division of said divisible property from prospective property buyers including at least said first prospective property buyer; and
awarding registration authority over said sub-division of said divisible property right to one of said prospective property buyers that submits the highest bid.

9. The system of claim 8, wherein said acquiring function further comprises receiving a request from said property owner to offer sub-divisions of said divisible property right for bid.

10. The system of claim 8, wherein said acquiring function further comprises locating an administrative service provider associated with said divisible property right.

11. The system of claim 8, wherein said initiating function further comprises initiating said auction having a predetermined time period.

12. The system of claim 11, wherein said divisible property auction application further comprises the function of terminating said auction when said predetermined time period expires.

13. The system of claim 8, wherein said divisible property further comprises a domain name.

14. The system of claim 8, wherein said divisible property further comprises an e-mail address.
